(19) United States
(12) Patent Application Publication
(10) Pub. No.: US 2026/0291018 A1
(43) Pub. Date: Sep. 24, 2026

(54) Parallel Battery Stacks

(71) Applicant: Stacked Energy, Inc., San Jose, CA (US)

(72) Inventors: Dylan Charles Erb, San Jose, CA (US); Christopher Thomas Szrom Campbell, San Jose, CA (US); Duc Trong Duong, San Jose, CA (US); Alexander Paul Bartlett, San Jose, CA (US); Edward Thomas Hillstrom, Vancouver (CA); Sumitha Durairaj, Fremont, CA (US); Russell Alexander Seeman, Pleasanton, CA (US); Abraham Bruno Caulk, Livermore, CA (US)

(21) Appl. No.: 19/570,990

(22) Filed: Mar. 18, 2026

Related U.S. Application Data
(60) Provisional application No. 63/774,061, filed on Mar. 18, 2025.

(51) Int. Cl. H01M 50/503; H01M 10/647; H01M 10/656; H01M 50/209; H01M 50/509; H01M 50/516; H01M 50/517

(52) U.S. Cl. CPC H01M 50/503; H01M 10/647; H01M 10/656; H01M 50/209; H01M 50/509; H01M 50/516; H01M 50/517

(57) ABSTRACT

Batteries, battery cells, and more generally energy storage devices, may be grouped in packs, where a battery may include multiple battery cells coupled together to provide a desired voltage or capacity. The multiple battery cells in a battery pack are stacked so that battery cells are next to each other in the same plane. Battery cells in the same plane are connected in parallel to each other using a parallelization connector that bridges a gap between adjacent battery cells that are in the same plane or electrically connects them by other means. The parallelization connector may be a strip, a frame, or a tape, or other conductive pathway, as will be further described below.

### CROSS-REFERENCE TO RELATED APPLICATIONS

This application claims the benefit of U.S. Provisional Patent Application No. 63/774,061, filed on Mar. 18, 2025, which is incorporated by reference herein in its entirety.

### TECHNICAL FIELD

The present technology relates to batteries. More specifically, the present technology relates to a battery pack having multiple battery cells next to each other in a same plane and connected to each other using a parallelization connector to create a parallel connection between the battery cells.

### BACKGROUND

Creating stacked battery packs that have large x/y footprint would normally require scaling all the materials (polymer current collectors, adhesives, electrodes, etc.) up to the full width/length of the pack. Acquiring or fabricating materials with roll widths of over 500 mm can be challenging due to limited availability of large enough equipment and difficulty maintaining consistent quality over such a large span. It can also be problematic to handle/transport battery cells that are so large.

To package the required energy in typical application spaces, multiple high voltage stacks need to be used to fill in the desirable/available Z space. Every cell needs to monitored and balanced. One solution for battery cell monitoring is to provide independent battery monitoring channels to each cell in a stack. However, such an approach adds cost to the battery monitoring system.

### BRIEF DESCRIPTION OF THE DRAWINGS

A further understanding of the nature and advantages of the disclosed embodiments may be realized by reference to the remaining portions of the specification and the drawings.

FIG. 1 shows a schematic cross-sectional view of a battery according to some embodiments of the present disclosure.

FIG. 2 shows a schematic cross-sectional view of a current collector according to some embodiments of the present disclosure.

FIG. 3A shows a schematic top view of a battery pack according to some embodiments of the present disclosure.

FIG. 3B is a cross-section view of the battery pack along line A-A of FIG. 3A according to some embodiments of the present disclosure.

FIGS. 4A and 4B respectively show a schematic side view and a schematic perspective view of a battery pack according to some embodiments of the present disclosure.

FIG. 5 illustrate components of a battery pack according to some embodiments of the present disclosure.

FIGS. 6A to 6J illustrate an example process for forming a battery pack with parallel stacked battery cells according to some embodiments of the present disclosure.

FIG. 7A shows a schematic side view of a battery cell with a composite tape assembly that seals an end of the battery cell according to some embodiments of the present disclosure.

FIG. 7B illustrates a schematic side view of the composite tape assembly according to some embodiments of the present technology.

FIG. 7C illustrates a schematic plan view of the battery cell with the composite tape assembly according to some embodiments of the present disclosure.

FIGS. 8A, 8B, 8C, and 8D illustrate exploded views of a battery pack according to some embodiments of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Batteries, battery cells, and more generally energy storage devices, may be grouped in packs, where a battery may include multiple battery cells coupled together to provide a desired voltage or capacity. The multiple battery cells in a battery pack are stacked so that battery cells are next to each other in the same plane. Battery cells in the same plane are connected in parallel to each other using a parallelization connector that bridges a gap between adjacent battery cells that are in the same plane or electrically connects them by other means. The parallelization connector may be a strip, a frame, or a tape, or other conductive pathway, as will be further described below.

Although the remaining portions of the description will routinely reference lithium-ion batteries, it will be readily understood by the skilled artisan that the technology is not so limited. The present designs may be employed with any number of battery or energy storage devices, including other rechargeable and primary, or non-rechargeable, battery types, as well as electrochemical capacitors also known as supercapacitors or ultracapacitors. Moreover, the present technology may be applicable to batteries and energy storage devices used in any number of technologies that may include, without limitation, phones and mobile devices, handheld electronic devices, laptops and other computers, appliances, heavy machinery, transportation equipment including automobiles, water-faring vessels, air travel equipment, and space travel equipment, as well as any other device that may use batteries or benefit from the discussed designs. Accordingly, the disclosure and claims are not to be considered limited to any particular example discussed, but can be utilized broadly with any number of devices that may exhibit some or all of the electrical or chemical characteristics of the discussed examples.

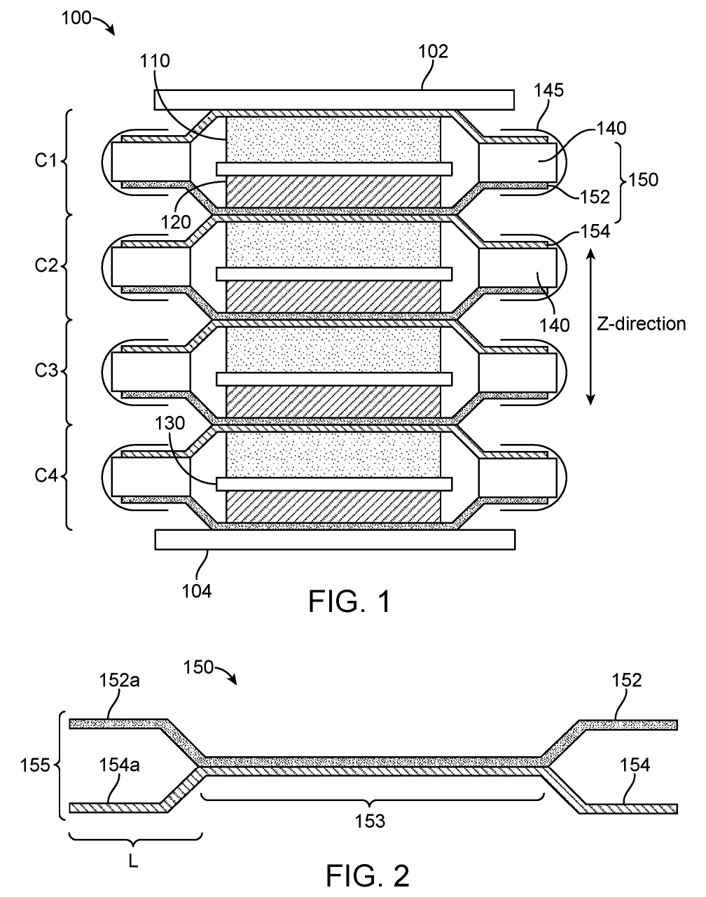

FIG. 1 depicts a schematic cross-sectional view of an energy storage device (e.g., a battery) according to embodiments of the present technology. The energy storage devices may include a single current collector or coupled current collectors. The energy storage devices may operate in a conventional manner with regard to electronic flow across or through material layers, such as providing electronic mobility across an xy-plane of the current collectors. Additionally, the described devices may operate by electronic flow through the structure in a z-direction through individual cells as opposed to via tabbed current collectors as described above for conventional batteries, where current is delivered laterally across a current collector to a tab, which may be accessed to deliver current from the cell.

As illustrated, the stacked battery 100 may include a stack of electrochemical cells C1, C2, C3, and C4 between end plates 102 and 104. End plates 102 and 104 may be metal current collector plates, which can serve both electrical and mechanical functions. In some embodiments, end plates 102 and 104 can be support plates that form part of an external housing of the stacked battery. End plates 102 and 104 may also provide mechanical support within a housing of the stacked battery. Some or all of the support plates may be electrically conductive, and there may be a terminal within the support plate that is electrically connected to the end plate. In embodiments an additional plate similar to end plates 102 and 104 may be disposed within the stack of cells, such as between two cells. This configuration including an additional plate may provide structural rigidity, and the additional plate may also perform electronic functions similar to end plates 102, 104. End plates 102 and 104 may act as positive and negative terminals of the battery. The cells may pass current in the z-direction through individual cells to the end plates, which may transfer current in any direction across the plate and from the battery.

The stack of electrochemical or battery cells may include any number of electrochemical cells depending on the selected voltage for the stacked battery 100, along with the individual voltage of each individual electrochemical cell. The cell stack may be arranged with as many or as few electrochemical cells in series as desired, as well as with intervening plates for support and current transfer. For example, batteries according to some embodiments of the present technology may include greater than or about 5 battery cells, and may include greater than or about 10, greater than or about 20, greater than or about 50, greater than or about 100, greater than or about 200, greater than or about 500, or more individual cells in a battery. The cells C may be positioned adjacent, e.g. abutting, one another in some configurations. Each electrochemical cell C may include a cathode 110 and an anode 120, where the cathode 110 and anode 120 may be separated by separator 130 between the cathode and anode. Between the anode 120 of cell C1 and the cathode of adjacent cell C2 may be a stacked current collector 150. The stacked current collector 150 may form part of C1 and C2. On one side, stacked current collector 150 may be connected to the seal 140 of C1 and connected on an opposing side to the seal 140 of C2.

In some embodiments, as shown in FIG. 1, stacked current collector 150 may include a first current collector 152 and a second current collector 154. In embodiments one or both of the current collectors may include a metal or a non-metal material, such as a polymer or composite. As shown in the figure, in some embodiments the first current collector 152 and second current collector 154 can be different materials. In some embodiments, the first current collector 152 may be a material selected based on the potential of the anode 120, such as copper or any other suitable metal, as well as a non-metal material including a polymer. The second current collector may be a material selected based on the potential of the cathode 110, such as aluminum or other suitable metals, as well as a non-metal material including a polymer. In other words, the materials for the first and second current collectors can be selected based on electrochemical compatibility with the anode and cathode active materials used.

The first and second current collectors can be made of any material known in the art. For example, copper, aluminum, or stainless steel may be used, as well as composite materials having metallic aspects, and non-metallic materials including polymers. In some instances the metals or non-metals used in the first and second current collector can be the same or different. The materials selected for the anode and cathode active materials can be any suitable battery materials. For example, the anode material can be silicon, graphite, carbon, a tin alloy, lithium metal, a lithium containing material, such as lithium titanium oxide (LTO), or other suitable materials that can form an anode in a battery cell. Additionally, for example, the cathode material can be a lithium-containing material. In some embodiments, the lithium-containing material can be a lithium metal oxide, such as lithium cobalt oxide, lithium manganese oxide, lithium nickel manganese cobalt oxide, lithium nickel cobalt aluminum oxide, or lithium titanate, while in other embodiments, the lithium-containing material can be a lithium iron phosphate, or other suitable materials that can form a cathode in a battery cell.

The first and second current collectors may have any suitable thickness, and may have a thickness that allows for a seal to be formed and provides suitable mechanical stability to prevent failure, such as breakage of the layers, during anticipated usage of the stacked battery. Additionally, the thickness of the current collectors can be sufficiently thin to allow for bending and flexing in the separation region to accommodate expansion anticipated during cycling of the stacked battery, including, for example, up to 10% expansion in the z-direction.

Turning to FIG. 2, the stacked current collector 150 may have a connection region 153 where the first current collector 152 and second current collector 154 may be connected, and a gap region 155 at the peripheral ends of the collector 150. In the connection region 153, the first current collector and second current collector may be in direct contact or otherwise joined to be electrically-conductive. In some embodiments, the first current collector and second current collector may be directly connected, while in other embodiments the first current collector and second current collector may be indirectly connected via a conductive material. To form the connection region 153, the first current collector 152 and the second current collector 154 may be laminated together. Additionally, the connection region 153 may be created by welding the first current collector 152 and the second current collector 154 together. The connection region 153 may also be created by using an adhesive, which may be electrically conductive, between the first current collector 152 and the second current collector 154. In other embodiments, the connection region 153 may be created by the wetting that can occur between the materials of the first current collector 152 and the second current collector 154.

In the gap region 155, the peripheral ends of the first current collector 152 and the second current collector 154 may be spaced apart and moveable relative to each other. As such, there may be a separation distance between the first and second current collectors, which may increase as the electrochemical cell swells. In some embodiments, the spaced apart peripheral ends of the first current collector 152 and the second current collector 154 may be of a length that is sufficient to accommodate an anticipated expansion of the individual electrochemical cells of the stacked battery during cycling of the battery. The peripheral ends of the current collectors 152a and 154a may have a length L, as shown in FIG. 2, which may be long enough that up to or at least about 10% expansion in the z-direction can be accommodated.

As shown in FIG. 1, each cell C1, C2, C3, and C4, also includes a seal 140, which, with the current collector layers, may electrochemically isolate the electrochemical cells from each other. Thus, each cathode-anode pair may be electrochemically sealed and isolated from neighboring electrochemical cells. Because the current collectors 152 and 154 may be separated at the peripheral ends, separate seals 140 can be formed on opposing sides, such as a top and bottom, of the stacked current collector 150. The seals 140 may be the same or different materials, and each seal 140 may also be a laminate, composite, or coupling of two or more materials in embodiments. In some embodiments, the end of the seal 140 may extend beyond the ends of the first current collector 152 and the second current collector 154 as shown in FIG. 1. In other embodiments, the ends of the first current collector 152 and the second current collector 153 extends beyond the end of the seal 140.

The seal material may be able to bond with the first and second layers of the stacked current collector to prevent electrolyte leakage. The seal material may be a polymer, an epoxy, or other suitable electrically-insulating material that can bond with first and second current collectors to create a seal, which may be a hermetic seal. In some embodiments, the polymer may be polypropylene, polyethylene, polyethylene terephthalate, polytrimethylene terephthalate, polyimide, or any other suitable polymer that may bond with the first and second current collectors of the stacked current collector to form a hermetic seal and may also provide resistance to moisture ingress. The electrolyte may be a solid, a gel, or a liquid in embodiments. The seal may electrochemically isolate each electrochemical cell by hermetically sealing the cell, thereby preventing ions in the electrolyte from escaping to a neighboring electrochemical cell. The seal material may be any material providing adequate bonding with the metal layers such that the seal may be maintained through a predetermined period of time or battery usage.

The separator may be wetted with the electrolyte, such as a fluid electrolyte or gel electrolyte, to incorporate the electrolyte into the stacked battery. Alternatively, a gel electrolyte may coat the separator. In still further alternatives, a gel electrolyte may coat the first metal layer and/or second metal layer before combination. Additionally, the electrolyte may be blended with particles of electrode active material. In various embodiments, incorporating the electrolyte into the components of the stacked battery may reduce gassing in the stacked battery. In variations that include a flexible seal, the stacked battery may accommodate gas resulting from degassing.

The individual electrochemical cells may be formed in any suitable manner. In some embodiments, the cathode 110, the anode 120, and the separator 130 may be preassembled. A first current collector 152 may then be connected to the anode while a second current collector 154 may be connected to the cathode to create a cell. The seal material may be disposed between the first current collector 152 and the second current collector 154 to form seals 140. Finally, the peripheral ends of the sealed electrochemical cell may be further taped to frame the cell. Tapes 145, as well as other coatings, sealing, or material layers, may be disposed around the outer perimeter of the metal layers and seals. The tape 145 may be substituted with ceramic or polymeric materials. Tape 145 may be included for various reasons including to prevent shorting to adjacent layers or to surrounding conductive surfaces within the device, to provide improved electrochemical or chemical stability, and to provide mechanical strength.

FIGS. 1 and 2 illustrate an exemplary stacked battery design according to the present technology. Additional configurations other than illustrated, or as variations on the designs, are also encompassed by the present technology. For example, certain embodiments may not include an additional seal material, and first current collector 152 and second current collector 154 may be directly coupled or bonded together. Additionally, the current collectors may include designs including combinations of polymer material and conductive materials, such as within a matrix.

An exemplary matrix for a current collector may include a polymer disposed as the matrix material or as part of the matrix material. The matrix may provide an insulative design that limits or reduces xy-directional conductivity. The polymer matrix may be developed with a conductive material to produce a current collector having particular electrochemical or composite properties, such as electrical conductivity in the z-direction or through the cell. For example, conductive particulate material may be incorporated within the matrix. The conductive material may include any of the conductive materials previously identified. In embodiments, the conductive material may include one or more of silver, aluminum, copper, stainless steel, and a carbon-containing material. In this way, the current collector may have a tuned resistivity to provide directional control for electrical conductivity. For example, the produced current collector may be configured to provide an in-plane resistivity across a length in the xy-plane, as well as a through-plane resistivity in the z-direction, which is greater than or about 1x10-4 ohm-m in embodiments. Additionally, exemplary current collectors may have an in-plane and through-plane resistivity of between about 1x10-3 ohm-m and about 1,000 ohm-m. In other embodiments, more conventional electrical distribution may be employed, where current is transferred along conductive current collectors into and out of the cell.

In one embodiment, the stacked battery architectures described herein includes various configurations for parallelization between different cell stacks. In one instance, the sheet resistance (xy-plane) of the current collectors for the battery architectures described herein, including polymer current collectors, ranges from 0.1-10 Ω/square, preferably 1-10 Ω/square to provide good parallelization capabilities between the cell stacks, while maintaining good safety properties.

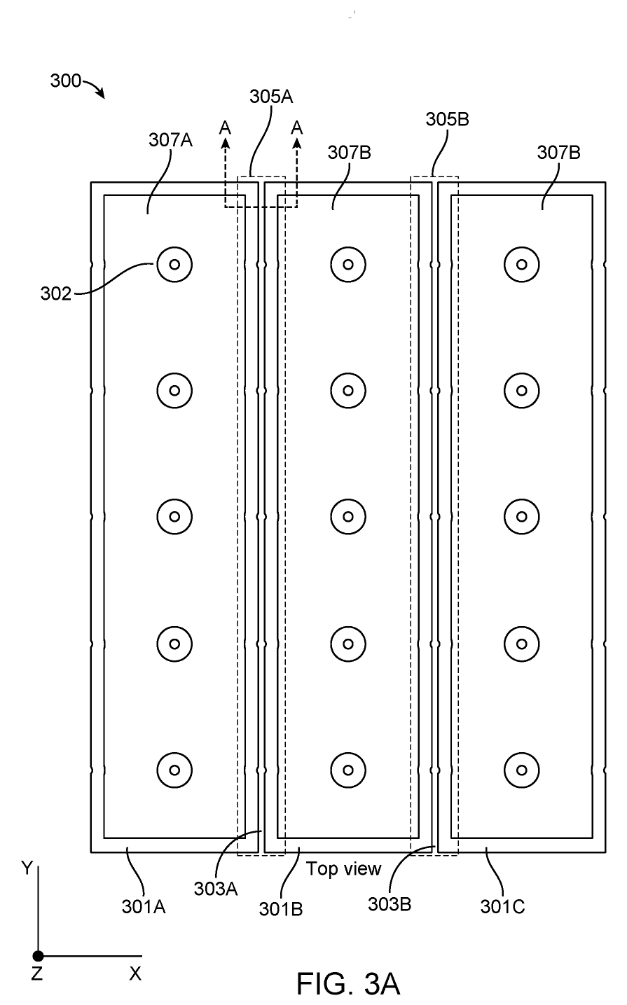

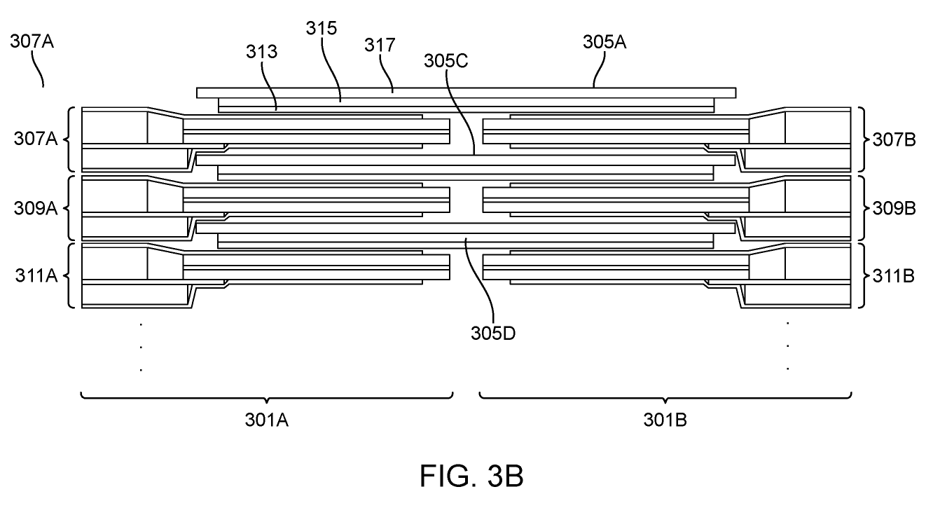

FIG. 3A shows a schematic top view of a portion of a battery pack 300 according to some embodiments of the present disclosure. The battery pack 300 includes a stack of multiple battery cells next to each other in the same plane (e.g., the X-plane). For example, the battery pack 300 includes a plurality of columns of batteries including column 301A, column 301B, and column 301C. Each column 301A, 301B, and 301C may have one or more batteries that are stacked on top of each other in the Z-direction where each battery has the structure of the battery 100 shown in FIG. 1. While the battery cells are shown to have a rectangular shape, the battery cells can be any shape.

As shown in FIG. 3A, column 301A, column 301B, and column 301C are arranged next to each other along the X-plane. For example, column 301A is arranged next to a first side of column 301B and column 301C is arranged next to a second side of column 301B that is opposite the first side such that column 301B is between column 301A and column 301C along the X-plane. A gap is formed between adjacent columns. For example, a gap 303A is located between column 301A and column 301B and a gap 303B is located between column 301B and column 301C.

Parallelization connectors are applied to electrically bridge the gap between neighboring battery cells that are included in adjacent columns and are located in a same X-Y plane to connect the neighboring battery cells in parallel. The parallelization connector may be applied along one or more edges of the neighboring battery cells. In some embodiments, a parallelization connector is a conductive strip, frame, or tape. After all the battery cells that are disposed in the same plane across the columns are connected in parallel via the parallelization connectors, the next layer of battery cells is laminated on top, followed by another layer of parallelization connectors to connect battery cells of the next layer in parallel. This process can be repeated until a number of battery cells has been connected in series to provide the desired system voltage.

FIG. 3A illustrates a topmost battery cell 307A in column 301A, a topmost battery cell 307B in column 301B, and a topmost battery cell 307C in column 301C that are connected in parallel via parallelization connectors 305A and 305B. Specifically, parallelization connector 305A is disposed over gap 303A and is connected to one or more edges of the topmost battery cell 307A and one or more edges at the first side of the of the topmost battery cell 307B to connect the topmost battery cells 307A and 307B in parallel. Similarly, parallelization connector 305B is disposed over gap 303B and is connected to one or more edge at the second side of the topmost battery cell 307B and an edge of the topmost battery cell 307C to connect the topmost battery cells 307B and 307C in parallel. As a result, the topmost battery cell 307A in column 301A, the topmost battery cell 307B in column 301B, and the topmost battery cell 307C in column 301C that are disposed in the same X-Y plane are connected in parallel.

In one embodiment, each battery cell 307 has one or more openings formed through an entire thickness of the battery cell. The openings of battery cells 307 stacked on each other within the same column overlap each other. For example, center points of the openings of the battery cells 307 within the same column may be substantially aligned with each other. A fastener 302 is disposed within each opening to secure the battery cells within the column to each other.

FIG. 3B is a cross-section view of a portion of the battery pack 300 along line A-A of FIG. 3A according to some embodiments of the present disclosure. As shown in FIG. 3B, column 301A includes multiple battery cells 307A, 309A, and 311A that are stacked on each other. Similarly, column 301B includes multiple battery cells 307B, 309B, and 311B that are stacked on each other. Battery cell 307A from column 301A is in the same plane as battery cell 307B from column 301B and are connected to each other in parallel via the parallelization connector 305A that is in contact with edges of the battery cell 307A and battery cell 307B. For example, the parallelization connector 305 is in contact with a current collector of the battery cell 307A and a current collector of the battery cell 307B.

Battery cell 309A from column 301A is in the same plane as battery cell 309B from column 301B and are connected to each other in parallel via the parallelization connector 305C that is in contact with edges of the battery cell 309A and battery cell 309B. Battery cell 311A from column 301A is in the same plane as battery cell 311B from column 301B and are connected to each other in parallel via the parallelization connector 305D that is in contact with edges of the battery cell 311A and battery cell 311B. Note that while FIG. 3B illustrates only a portion of a single battery included in each of column 301A and 301B, each of column 301A and 301B may include multiple batteries that are stacked on each other in the Z-direction.

In some embodiments, the parallelization connector is a composite that includes a conductive adhesive 313, a conductive metal layer 315 that is on the conductive adhesive 313, and an insulating layer 313 on the conductive metal layer 315 such that the conductive metal layer 315 is between the conductive adhesive 313 and the insulating layer 317. The insulating layer 317 is the topmost layer of the parallelization connector to prevent shorting of adjacent battery cells that are stacked on top of each other in the Z-direction. An example of the material of the conductive adhesive 313 is Polyisobutylene (PIB) with a carbon filler. The conductive metal layer 315 may be copper or aluminum. Lastly, the insulating layer 317 may be Polypropylene (PP), Polyimide (PI), Polyvinyl chloride (PVC), or polyethylene terephthalate (PET).

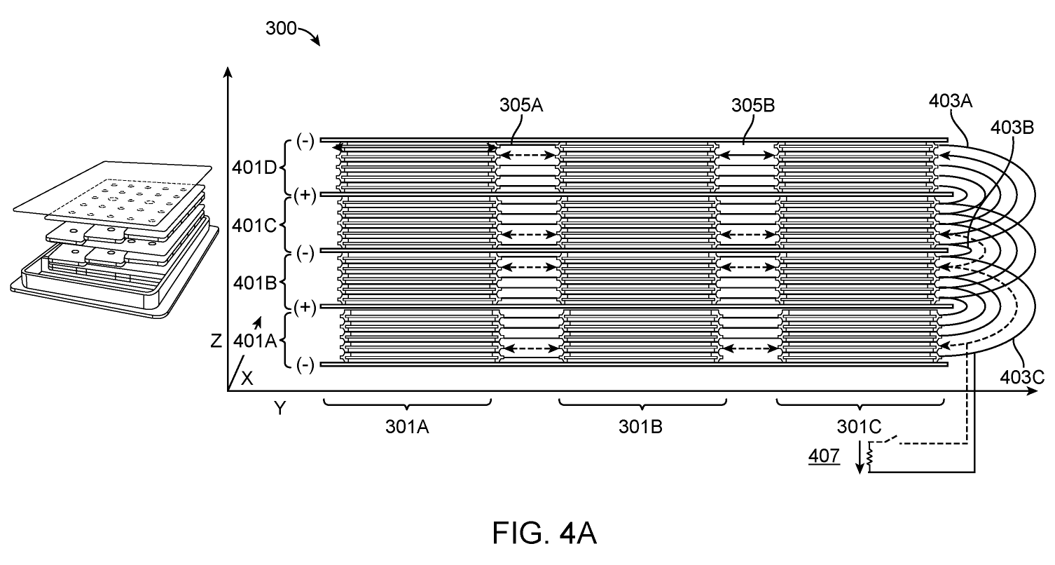

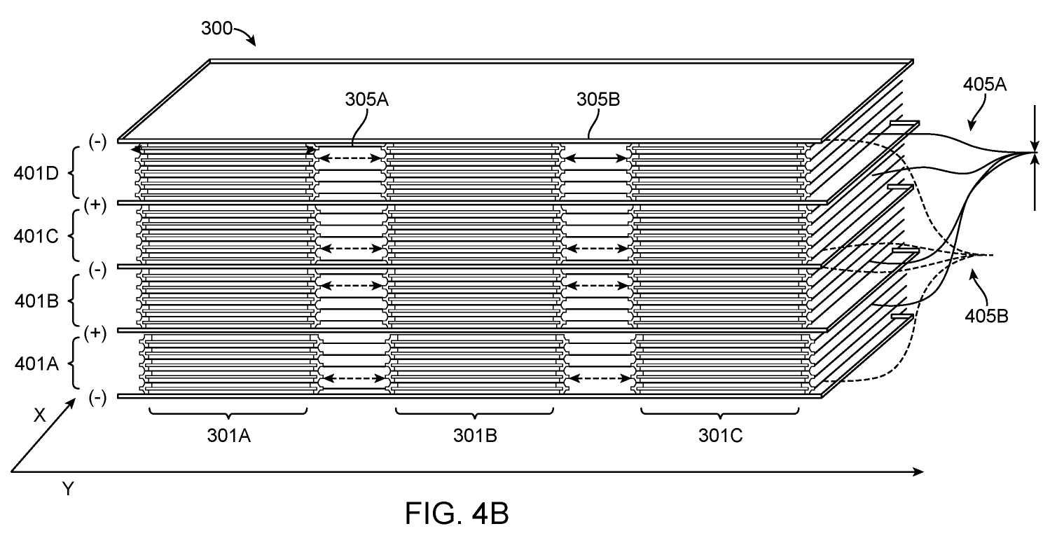

In one embodiment, the parallelization connector can also be used to perform the function of a balancing frame. Furthermore, a similar parallelization connector can also be used to provide parallel connections between battery cells that are in different battery stacks disposed in the Z-direction as described below with respect to FIGS. 4A and 4B. Tabs of the parallelization connector can stick out the side of battery cells, and then be joined together through either conductive pressure sensitive adhesives (PSAs), ultrasonic welds, rivets, or other mechanical joining methods, for example.

FIGS. 4A and 4B respectively show a schematic side view and a schematic perspective view of a portion of the battery pack 300 according to some embodiments of the present disclosure. As shown in FIGS. 4A and 4B, battery cells from different columns 301A, 301B, and 301C that are in the same X-Y plane are connected together in parallel using parallelization connectors, as previously described above. For example, parallelization connectors 305A and 305B connect in parallel the topmost battery cells that are in the same plane within columns 301A, 301B, and 301C. As a result, of the parallel connection structure, battery cells that are disposed along the same X-Y plane across the different battery columns are connected together in parallel and have voltage balance (e.g., a substantially same voltage).

As mentioned above, each column comprises a plurality of stacked batteries that each have multiple battery cells to collectively form the column. As a result, the battery pack 300 includes a plurality of row groups of battery cells in the X-Y plane where each row group of battery cells spans a plurality of columns. The row groups of battery cells that span the columns and are located between a common anode current collector and a common cathode current collector form a row of batteries. For example, the battery pack 300 includes a row group of batteries 401A, a row group of batteries 401B, a row group of batteries 401C, and a row group of batteries 401D where each row group of batteries includes a plurality of rows of battery cells included in columns 301A, 301B, and 301C. Each row of battery cells has a height measured with respect to a bottom of the battery pack that is unique to the row of battery cells.

In one embodiment, each row of battery cells within a given row group of batteries is connected in parallel to another row of battery cells within one or more other row groups of batteries. As shown in FIG. 4A, each row of battery cells included in the row group of batteries 401D is connected in parallel to a row of battery cells in the row group of batteries 401C, a row of battery cells in the row group of batteries 401B, and a row of battery cells in the row group of batteries 401A where each of the parallel connected battery cells have the same potential within their respective row of batteries.

For example, the topmost row of battery cells in row group of batteries 401D is connected to a row of battery cells in the row group of batteries 401C via a parallelization connector 403A (e.g., a parallelization tab). The row of battery cells in the row group of batteries 401C that is connected to the topmost row of battery cells in the row group of batteries 401D is also connected to a row of battery cells in the row group of batteries 401B via parallelization connector 403B. The row of battery cells in the row group of batteries 401B that is also connected to the row of battery cells in the row group of batteries 401C that is connected to the topmost row of battery cells in the row group of batteries 401D is also connected to a row of battery cells in the row group of batteries 401A via parallelization connector 403C. Thus, each parallelization connector 403 connects a first row of battery cells that is located at a first height corresponding to the first row of battery cells with a second row of battery cells that is located at a second height corresponding to the second row of battery cells where the second height is different from the first height.

In one embodiment, the cells in a row group of cells 401A are arranged such that for each cell, the anode electrode is placed below the cathode electrode of the cell. On the other hand, the cells in a row group of cells 401B placed above the row group of cells 401A are arranged such that for each cell, the anode electrode is placed above the cathode electrode of the cell. The cells in a row group of cells 401C are arranged again such that for each cell, the anode electrode is placed below the cathode electrode of the cell. The cells in a row group of cells 401D are arranged such that for each cell, the anode electrode is placed above the cathode electrode of the cell.

Thus, since the cells at the negative-most potentials are parallelized, the bottom-most cell in the row group of cells 401A, the top-most cell in the row-group of cells 401B, the bottom-most cell in the row group of cells 401C, and the top-most cell in the row group of cells 401D are electrically connected to one another. Moreover, since the cells at the positive-most potentials are parallelized, the top-most cell in the row group of cells 401A, the bottom-most cell in the row-group of cells 401B, the top-most cell in the row group of cells 401C, and the bottom-most cell in the row group of cells 401D are electrically connected to one another.

However, it is appreciated that embodiments are not limited hereto, and any appropriate parallelization configuration can be used to parallelize cells in the stacked battery. For example, in one embodiment, the cells in each row group of cells 401A, 401B, 401C, 401D may be arranged such that for each cell, the anode electrode is placed below the cathode electrode of the cell.

Thus, since the cells at the negative-most potentials are parallelized, the bottom-most cell in each row group of cells 401A, 401B, 401C, 401D may be electrically connected to one another. Moreover, since the cells at the positive-most potentials are parallelized, the top-most cell in each row group of cells 401A, 401B, 401C, 401D may be electrically connected to one another.

In one embodiment, each of the parallelization connectors 403 that connect together rows of battery cells in different row groups of batteries are tabs having a similar foil/tape construction as described with respect to FIG. 3B. Alternatively, the parallelization connectors 403 are strips of conductive material such as copper. Each of the tabbed parallelization connectors 403 protrude from the side of one or more of the columns 301A, 301B, and 301C. As shown in FIGS. 4A and 4B, the tabbed parallelization connectors 403 extend from the side of battery column 301C in one example. The tabbed parallelization connectors 403 can be placed in different locations anywhere around the X-Y perimeter of the battery pack 300 so that connections can be made without interference with other tabbed parallelization connectors 403 from different rows of battery cells.

Tabbed parallelization connectors that connect together rows of battery cells in different row groups of batteries are electrically connected to each other by physically connecting together the ends of the tabbed parallelization connectors. For example, ends 405A of tabbed parallelization connectors are physically connected to each other as shown in FIG. 4B. Similarly, ends 405B of tabbed parallelization connectors are physically connected to each other. The physical connection can be made using different techniques such as conductive pressure-sensitive adhesive, ultrasonic welding, or rivets. The physical connection can also be made using mechanical connectors that apply pressure to the ends of the tabbed parallelization connectors such as spring-loaded clamps or mechanical crimping devices such as copper rings similar to wire crimping connectors.

In one embodiment, a cell monitoring circuit receives current 407 from the tabbed parallelization connectors. The cell monitoring circuit is configured to equalize the voltage and charge of battery cells in the battery pack 300 based on the received current 407.

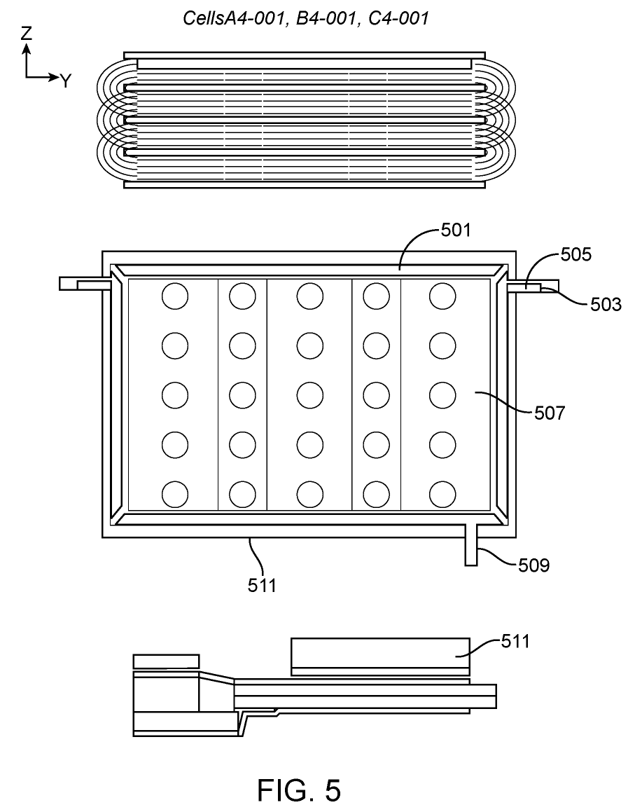

FIG. 5 illustrates components of a battery pack according to some embodiments of the present disclosure. In some embodiments, the battery pack 300 may include a plurality of balancing frames 501 for balancing the battery cells. Each balancing frame 501 may be disposed along the perimeter of a corresponding row of battery cells. The balancing frame 501 can be made of a plurality of discrete portions of conductive material or a made from a single piece of conductive material. In one embodiment, the balancing frame is made of metal tape such as copper tape with a conductive adhesive to adhere the balancing frame to the row of battery cells. The balancing frame may be converted on a carrier liner or manually placed on the row of battery cells.

In one embodiment, a sensing connection 509 is conductive material that extends from each balancing frame 501. The sensing connection is for connecting the row of battery cells to a cell monitoring module that balances the battery cells in the battery pack 300. The sensing connection may be a conductive tape such as a copper tape or a flexible printed circuit board. The sensing connection may be omitted if the tabbed parallelization connectors are used for cell monitoring.

In one embodiment, a compressive material 511 such as foam may be disposed around the perimeter of one or more rows of battery cells. The compressive material 511 may be disposed along the edges of a row of battery cells for cell-to-cell isolation and frame compression. The compressive material 511 may be disposed along the perimeter of each row of battery cells or can be disposed periodically such as every n-th row of battery cells, where n can be any integer number. For example, the compressive material 511 may be disposed along the perimeter of each row of battery cells or can be disposed periodically such as every tenth row of battery cells.

As described above, each row of battery cells has one or more tabbed parallelization connectors 503 that extend from the end of the row and are used to connect the row of battery cells to other rows of battery cells located in a different row of batteries. Each tabbed parallelization connector 503 may include an insulator 505 on top of the conductive portion of the tabbed parallelization connector 503. The insulator 505 prevents a short between adjacent tabbed parallelization connectors 505.

In some embodiments, a conductive adhesive 507 is disposed on one or more surfaces of each battery cell. For example, the conductive adhesive 507 is disposed on an upper surface of each battery cell. The conductive adhesive 507 ensures adequate contact is made between stacked battery cells.

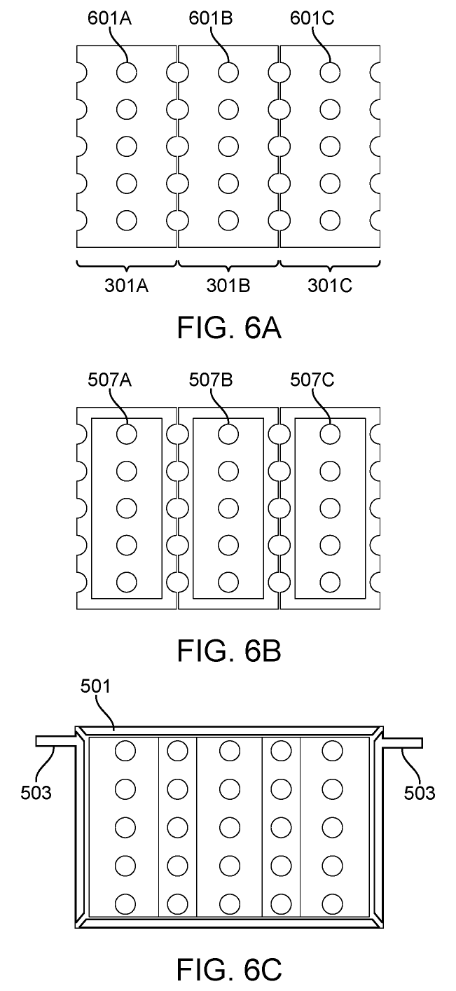

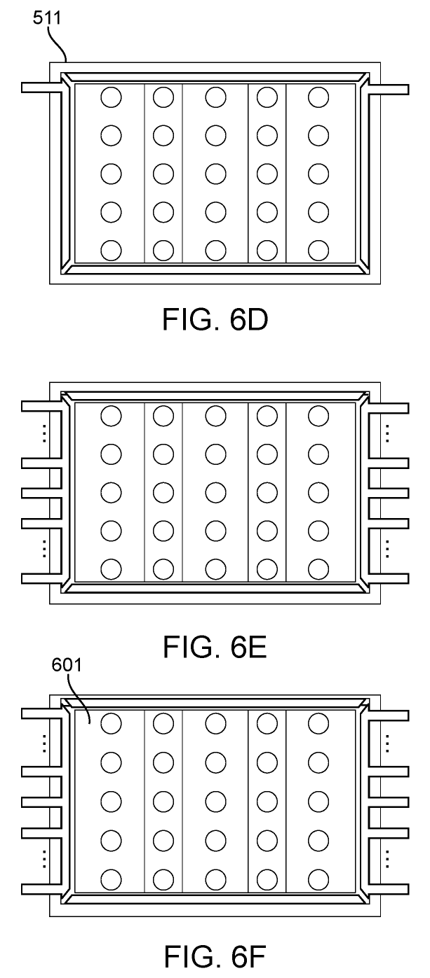

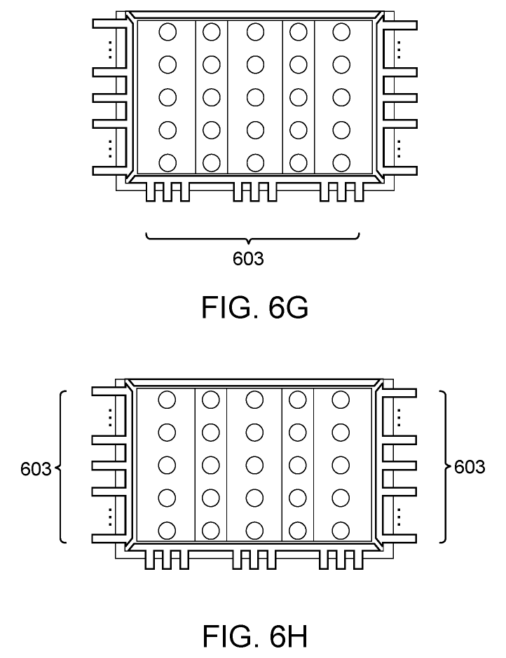

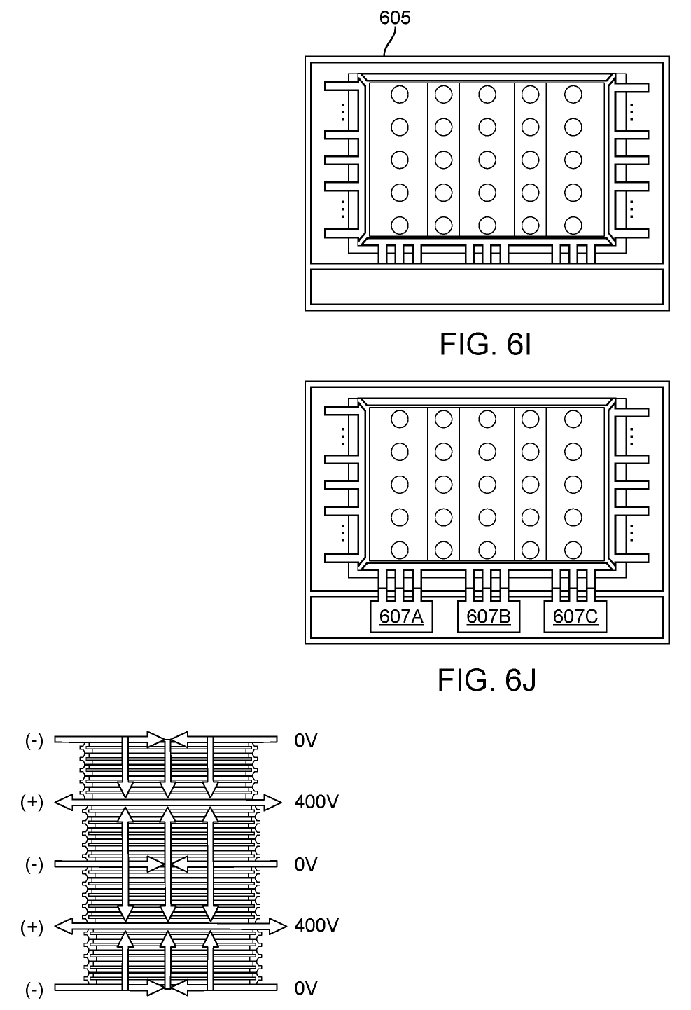

FIGS. 6A to 6J illustrate an example process for forming a battery pack with parallel stacked battery cells according to some embodiments of the present disclosure. In FIG. 6A, the first battery cells 601A, 601B, and 601C of columns 301A, 301B, and 301C are aligned and placed onto an assembly plate. The battery cell placement may be based on relative bolt hole locations of the pack frame.

In FIG. 6B, cell-to-cell adhesives are aligned and placed on a surface of each battery cell 601A, 601B, and 601C. For example, adhesive 507A is disposed on an upper surface of battery cell 601A, adhesive 507B is disposed on an upper surface of battery cell 601B, and adhesive 507C is disposed on an upper surface of battery cell 601C. Each adhesive 507 is aligned on a per cell basis.

In FIG. 6C, a balancing frame 501 is disposed along the perimeter of the battery cells 601A, 601B, and 601C. As mentioned above, the balancing frame 501 may comprise a conductive tape (e.g., copper tape) that can be made of a plurality of discrete pieces or a single integrated piece. FIG. 6C also illustrates a plurality of tabbed parallelization connectors 503 that are connected to the balancing frame 501. In one embodiment, an insulation tap may be disposed on the balancing frame 501 as needed.

In FIG. 6D, the perimeter foam 511 is placed along the perimeter of the of battery cells 601A, 601B, and 601C.

In FIG. 6E, the steps shown in FIGS. 6A to 6D are repeated a plurality of times to form a first stack of battery cells in each of the battery columns 301A, 301B, and 301C. In one embodiment, 102 individual tabbed parallelization connectors are formed that correspond to 102 battery cells in series.

In FIG. 6F, a current collector is applied to the first stack of battery cells to form a first battery in each of the columns 301A, 301B, and 301C. A heat exchanger HEX may also be applied on the current collector.

In FIG. 6G, the steps shown in FIGS. 6E and 6F are repeated a plurality of times to form multiple stacked batteries in each of the columns 301A, 301B, and 301C to achieve the desired voltage for the battery pack 300. In one embodiment, the rows of battery cells included in the uppermost row group of batteries (e.g., row group 401D in FIGS. 4A and 4B) also include front tabs 603 that protrude from the rows of battery cells.

In FIG. 6H, the parallelization connectors 603 are connected together to form parallel connections between each row of battery cells within a row group of batteries with other rows of battery cells included in the other row groups of batteries of the battery pack 300 as previously described with respect to FIGS. 4A and 4B.

In FIG. 6I, a frame 605 is placed onto the battery pack 300.

In FIG. 6J, the front tabs 603 are connected to a cell monitoring system 607 that monitors the voltage/current of each battery cell and performs cell balancing on the battery cells of the battery pack. In one embodiment, each column of batteries is connected to its own corresponding cell monitoring system. For example, the front tabs 603 of the column 301A is connected to cell monitoring system 607A, the front tabs 603 of the column 301B are connected to cell monitoring system 607B, and the front tabs 604 of the column 301C are connected to cell monitoring system 607C.

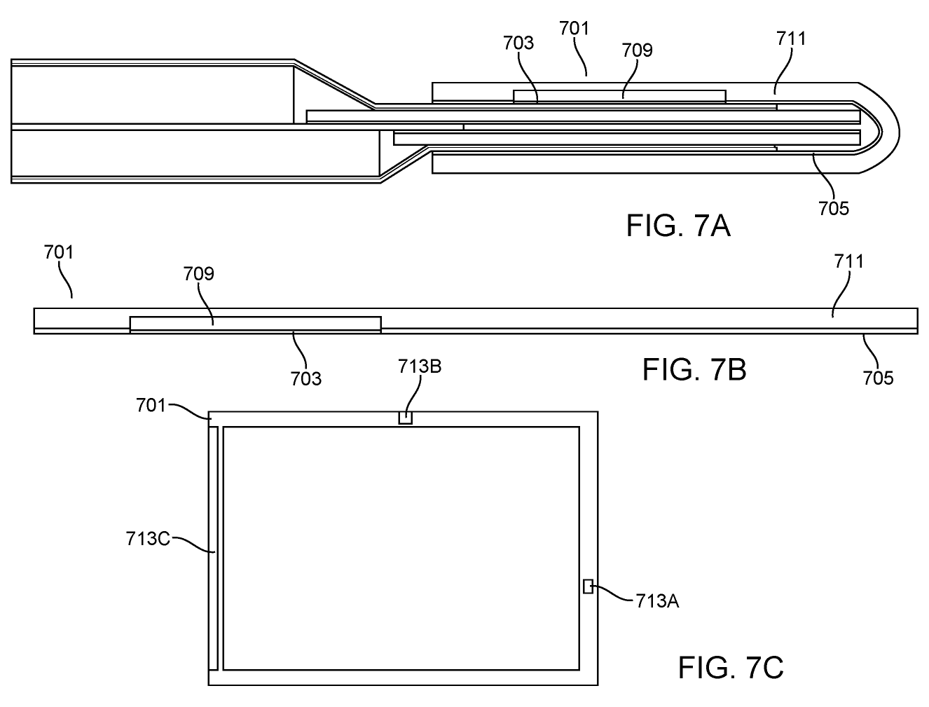

FIG. 7A shows a schematic side view of a battery cell with a composite tape assembly 701 that seals an end of the battery cell according to some embodiments of the present disclosure. FIG. 7B illustrates a schematic side view of the composite tape assembly 701 according to some embodiments of the present technology. FIG. 7C illustrates a schematic plan view of a row of battery cells with the composite tape assembly 701 according to some embodiments of the present disclosure.

In some embodiments, a composite tape assembly 701 is disposed around the perimeter of a row of battery cells as shown in FIG. 7C. The composite tape assembly 701 functions as a balancing frame and a sealing tape. The composite tape assembly 701 wraps around the ends of the current collectors of the battery cells in the row of battery cells as shown in FIG. 7A. The composite tape assembly 701 which, with the current collector layers, may electrochemically isolate electrochemical cells from each other.

In one embodiment, the composite tape assembly 701 includes a conductive adhesive 703 and a non-conductive adhesive 705 around the perimeter of the conductive adhesive 703. The conductive adhesive 703 and the non-conductive adhesive 705 may have a same thickness such that upper surfaces of the conductive adhesive 703 and the non-conductive adhesive 705 are planar with each other and lower surfaces of the conductive adhesive 703 and the non-conductive adhesive 705 are planar with each other. The lower surfaces of the conductive adhesive 703 and the non-conductive adhesive 705 may contact current collectors of the row of battery cells. The conductive adhesive 703 and the non-conductive adhesive 705 secure attachment to the battery cells while enabling parallel connections.

A conductive balancing frame 709 may be disposed on the upper surface of the conductive adhesive 703 without being disposed on the upper surface of the non-conductive adhesive 705. The conductive balancing frame 709 provides electrical connectivity for voltage balancing. The conductive balancing frame 709 simplifies pack assembly, improves thermal stability, and enhances reliability by reducing interconnect complexity.

The conductive balancing frame 709 may be made of conductive material such as metal (e.g., copper). An insulator 711 is disposed on the upper surface of the non-conductive adhesive 705 so as to cover the conductive balancing frame 709. The insulator 711 is made of a hermetic polymer for example. The insulator 711 prevents moisture ingress and enhances mechanical durability of the row of battery cells.

In one embodiment, one or more portions 713 of the conductive balancing frame 709 are exposed through the insulator 711. The cell monitoring system may be connected to the exposed portions 713 of the conducive balancing frame 709. The exposed portions may include exposed portion 713A, exposed portion 713B, and exposed portion 713C. Each exposed portion 713 may be disposed along a different side of the row of battery cells. Also, a size of each exposed portion 713 may be different.

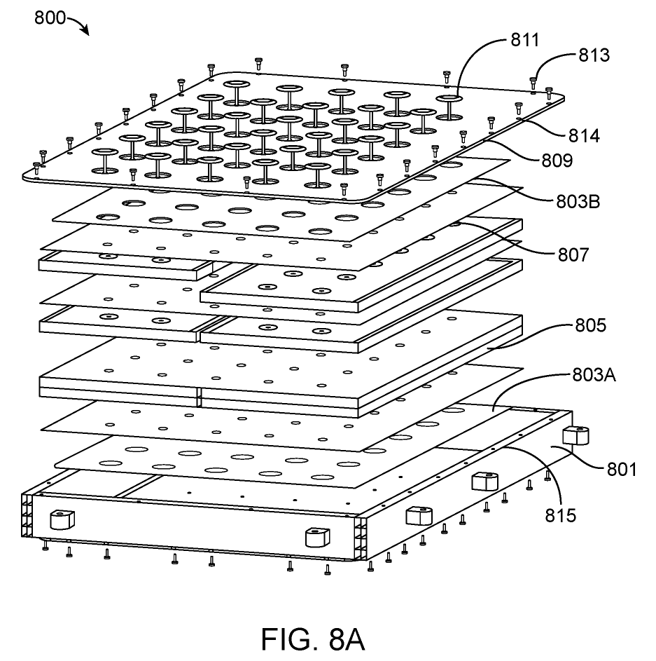

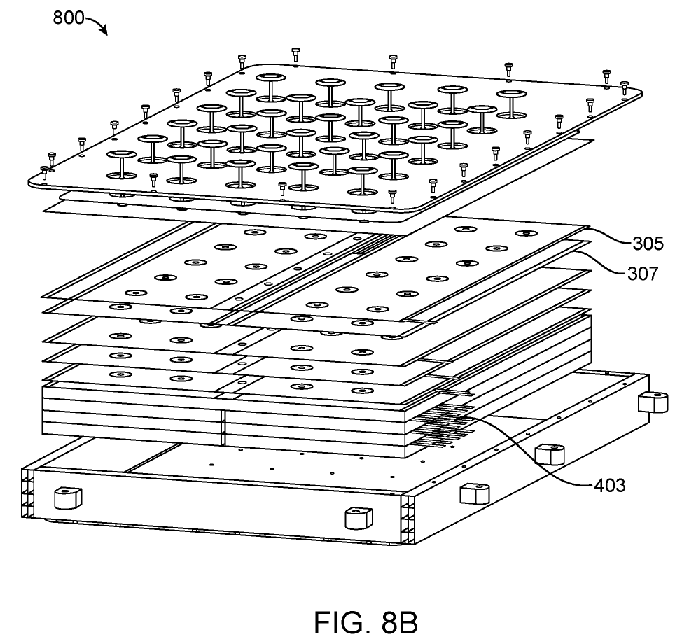

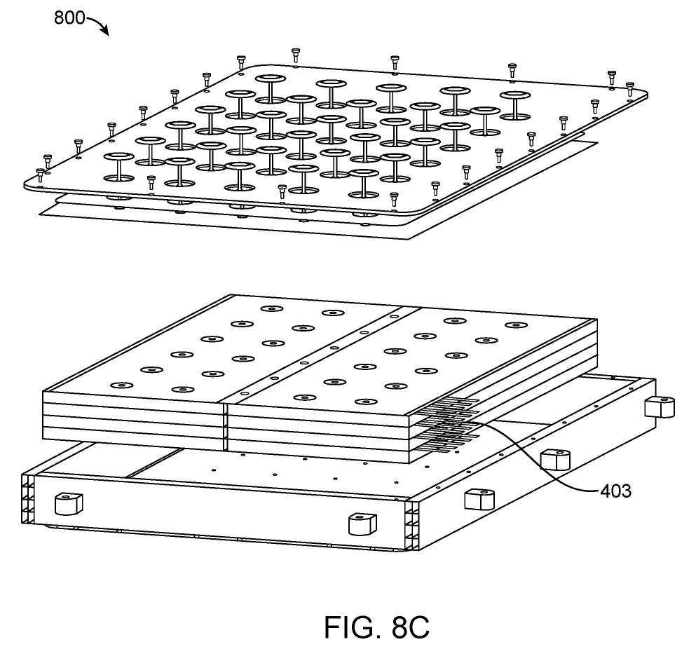

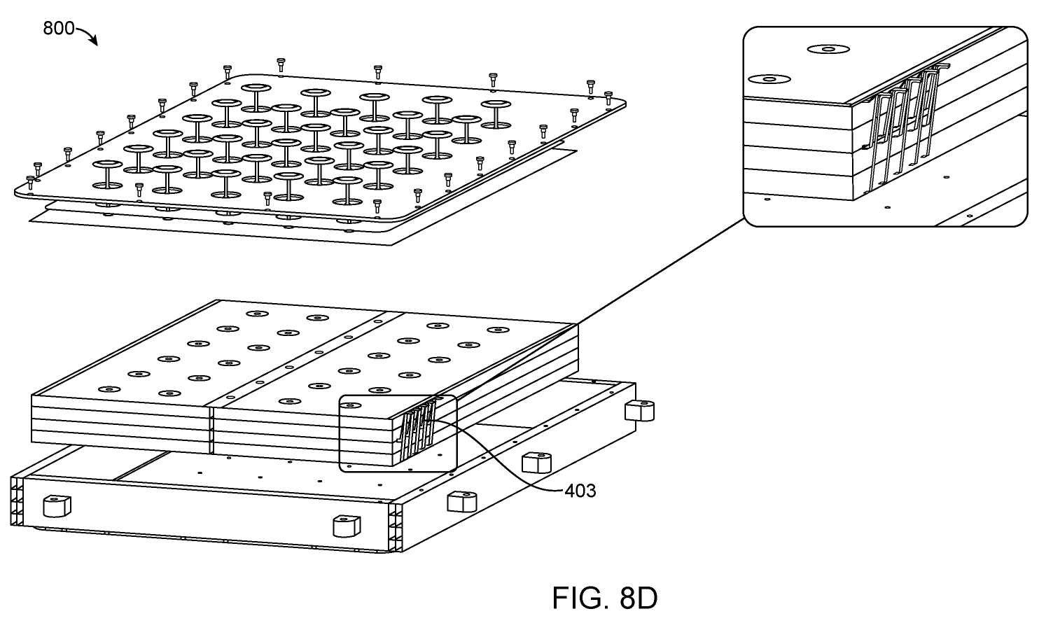

FIGS. 8A, 8B, 8C, and 8D illustrate exploded views of a battery pack 800 according to some embodiments of the present disclosure. The battery pack 800 includes a lower enclosure 801. The lower enclosure 801 is configured to house components of the battery pack shown in FIG. 8A. The lower enclosure 801 is an example of the frame 605 described with respect to FIG. 6I. The lower enclosure may be made of metal or a composite material. The lower enclosure 801 may include multiple holes or openings formed through the entire thickness of the bottom surface of the lower enclosure 801 through which fasteners 811 are disposed as will be further described below.

The lower enclosure 801 may include a heat exchanger. The heat exchanger includes channels or hollow spaces formed in the side walls of the lower enclosure 801. Cooling fluid or air may circulate through the channels to cool the battery pack 800.

In one embodiment, one or more heat exchangers may be placed in any appropriate location within the battery pack 800. In one embodiment, one or more components of a heat exchanger are placed between any appropriate pair of cell stacks including a first cell stack and a second cell stack that have parallel connections with one another. For example, a heat exchanger may be placed between cell stacks in row group 401B in FIG. 4B and cell stacks in row group 401C in FIG. 4B. As yet another example, a heat exchanger may be placed between cell stacks 805A and 805B in FIG. 8A. Moreover, additional current collectors can be disposed on the top or bottom of the heat exchanger.

A first compliant pad 803A is disposed on the bottom surface of the lower enclosure 801. The first compliant pad 803A is configured to deform or flex under load. The first compliant pad 803A may be made of material such as rubber, for example. The first compliant pad 803A may include holes or openings formed through the entire thickness of the first compliant pad 803A. The holes of the first compliant pad 803A are aligned with holes of the battery cells, holes of the impedance-balanced current collectors 807, and holes of the lower enclosure 801.

A plurality of cell stacks 805 are disposed on the first compliant pad 803A. The cell stacks 805 are arranged in the columns and rows of batteries as previously described above. Although each cell stack 805 is shown as a single block, the cell stack 805 may include any number of battery cells within the cell stack 805 that are stacked in the Z-direction. For example, the cell stack 805 may include between 50 to 200 individual cells that are vertically stacked on each other. In another example, the cell stack 805 may include between 10 to 14 individual cells that are vertically stacked on each other for a 48 volt system. As described above each battery cell has multiple holes through the thickness of the battery cell. The holes in each battery cell are aligned with holes of one or more battery cells that are stacked on top of the battery cell as well as the holes in the first compliant pad 803A and the holes in the lower enclosure 801.

Each cell stack 805 may be disposed between a pair of impedance-balanced current collectors (IBCC) 807 as shown in FIG. 8A. Given the battery pack 800 includes multiple cell stacks, the battery pack 800 may include multiple pairs of IBCCs 807. Each IBCC 807 includes multiple holes that overlaps holes of the battery cells, the holes of the first compliant pad 803A, and the holes of the lower enclosure 801.

A second compliant pad 803B may be placed on the topmost IBCC 807 within the battery pack 800. Similar to the first compliant pad 803B, the second compliant pad 803B includes multiple holes that overlap the holes of the battery cells, holes of the IBCCs 807, holes of the first compliant pad 803A, and holes of the lower enclosure 801.

A top plate 809 is disposed on the second compliant pad 803B. The top plate 809 has multiple holes or openings formed through the entire thickness of the top plate 809. The holes of the top plate 809 overlap the holes of the second compliant pad 803B, holes of the battery cells, holes of the IBCCs 807, holes of the first compliant pad 803A, and holes of the lower enclosure 801.

The top plate 809 functions as a compression plate. Multiple fasteners 811 (e.g., through-bolts) are disposed in the holes of the top plate 809, holes of the compliant pad 803B, holes of the IBCCs 807, holes of the battery cells, holes of the first compliant pad 803A, and holes of the lower enclosure 801. The ends of the fasteners 811 are secured with nuts to compress the components disposed between the top plate 809 and the bottom surface of the lower enclosure 801. Alternatively, the holes in the lower enclosure 801 are threaded and the ends of the fasteners 811 screw into the threaded holes of the lower enclosure 801. Compressing the components between the top plate 809 and the lower enclosure ensures connection between the stacked battery cells within the battery pack 800.

In one embodiment, the top plate 811 also includes auxiliary holes 814 around the periphery of the top plate 811. Auxiliary fasteners 813 fasten the top plate 809 directly to the periphery of the lower enclosure 801. The lower enclosure 801 may include threaded holes 815 in the upper surface of the side walls of the lower enclosure 801 and the auxiliary fasteners 813 screw into the threaded holes.

FIGS. 8B and 8C illustrate exploded views of the battery pack 800 with the parallelization connectors and parallelization tabs according to one embodiment. Specifically, FIG. 8B illustrates parallelization connectors 305 that electrically connect together pairs of battery cells 307 in the battery pack 800. As described above, each parallelization connector 305 is disposed on the edges of a pair of battery cells 307 that are located in the same plane within the battery pack 800 to connect the pair of battery cells 307 in parallel.

As described above, a parallelization tab 403 extends from the parallelization connector 305 of each battery cell past the edge of the battery cell. The parallelization tabs 403 are used to connects the battery cells belonging to different battery stacks as previously described above.

FIG. 8C illustrates multiple stacks of battery cells that are stacked on each other and are ready to be connected to each other using the parallelization tabs 403.

FIG. 8D illustrates another exploded view of the battery pack 800 according to one embodiment. In FIG. 8D, the parallelization tabs 403 are connected so that rows of battery cells included in different row groups of batteries are connected to each other as described with respect to FIGS. 4A and 4B. As shown in FIG. 8D, the ends of at least two parallelization tabs 403 are connected together to form the electrical connection between rows of battery cells disposed in different row groups of batteries. The ends of the parallelization tabs 403 may be soldered together, welded, or crimped to form the electrical connection, for example.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a material” includes a plurality of such materials, and reference to “the cell” includes reference to one or more cells and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A battery pack comprising:
a first cell stack comprising a first plurality of cells, wherein the first plurality of cells are stacked on one another and are connected in series; and
a second cell stack comprising a second plurality of cells, wherein the second plurality of cells are stacked on one another and are connected in series,
wherein the first plurality of cells are parallelized with the second plurality of cells,wherein the second cell stack is horizontally adjacent to the first cell stack, wherein a first cell in the first cell stack is disposed along a same plane as a second cell in the second cell stack, and wherein the first cell is electrically connected to the second cell in parallel.

2. (canceled)

3. The battery pack of claim 1, further comprising:
a conductive connector disposed along a first edge of the first cell and a second edge of the second cell to electrically connect the first cell and the second cell.

4. The battery pack of claim 3, wherein the conductive connector contacts a current collector of the first cell and a current collector of the second cell.

5. The battery pack of claim 3, wherein the conductive connector comprises:
a conductive adhesive;
a conductive metal layer on the conductive adhesive; and
an insulating polymer film on the conductive metal layer.

6. The battery pack of claim 1, wherein a third cell stack is disposed above the first cell stack, and the first cell in the first cell stack located at a first height is electrically connected in parallel to a third cell in the third cell stack at a third height different from the first height.

7. The battery pack of claim 6, further comprising:
a first row group of cells including one or more cell stacks arranged horizontally adjacent to one another, the one or more cell stacks including the first cell stack; and
a third row group of cells including one or more other cell stacks arranged horizontally adjacent to one another, the one or more other cell stacks including the third cell stack.

8. The battery pack of claim 7, further comprising:
wherein a first row of cells in the first row group of cells and a third row of cells in the third row group of cells are electrically connected in parallel.

9. The battery pack of claim 8, further comprising:
a first parallelization connector protruding from the first row of cells; and
a third parallelization connector protruding from the third row of cells,
wherein an end of the first parallelization connector and an end of the third parallelization connector are electrically connected to one another.

10. The battery pack of claim 9, wherein the end of the first parallelization connector and the end of the third parallelization connector are soldered together, welded, or crimped to form the electrical connection.

11. The battery pack of claim 7
wherein in the first row group of cells, cells are arranged such that an anode of each cell is placed below a cathode of the respective cell,
wherein in the third row group of cells, cells are arranged such that an anode of each cell is placed above a cathode of the respective cell.

12. The battery pack of claim 11, wherein a first row of cells is a bottom-most row of the first row group of cells, and wherein a third row of cells is a top-most row of the third row group of cells.

13. The battery pack of claim 11, wherein a first row of cells is a top-most row of the first row group of cells, and wherein a third row of cells is a bottom-most row of the third row group of cells.

14. The battery pack of claim 6, further comprising:
a row of cells including the first cell, wherein the row of cells are disposed along a same plane; and
a balancing frame disposed along a perimeter of the row of cells, the balancing frame including a conductive material.

15. The battery pack of claim 14, wherein the balancing frame is part of a composite tape assembly, wherein the composite tape assembly seals one or more ends of the row of cells.

16. The battery pack of claim 14, further comprising:
a perimeter foam disposed around the perimeter of the row of cells.

17. The battery pack of claim 1, further comprising:
a lower enclosure, wherein the lower enclosure is configured to house at least the first cell stack and the second cell stack; and
a top plate disposed on the lower enclosure.

18. The battery pack of claim 17, further comprising:
a heat exchanger, at least a part of the heat exchanger placed between the first cell stack and a third cell stack disposed above the first cell stack.

19. The battery pack of claim 18, further comprising:
one or more current collectors disposed above or below the heat exchanger.

20. The battery pack of claim 1, wherein a sheet resistance of a cell in the first plurality of cells is between 0.1-10 S2/square.
